(19) United States
(12) Patent Application Publication
(10) Pub. No.: US 2011/0010895 A1
(43) Pub. Date: Jan. 20, 2011

(54) Stethoscope keeper & Fastening Device

(76) Inventor: Robin Wesley Ream, South Jordan, UT (US)

Correspondence Address: Kent J. Trembly, P. O. Box 3, Wahoo, NE, 68066, US

(21) Appl. No.: 12/658,443

(22) Filed: Feb. 6, 2010

Related U.S. Application Data
(60) Provisional application No. 61/207,008, filed on Feb. 6, 2009.

(51) Int. Cl. F16B 2/00

(52) U.S. Cl. 24/129 R

(57) ABSTRACT

A device for keeping stethoscopes in place when not being used for healthcare personnel. This device allows the tubes on the stethoscope to slip into the stethoscope keeper and when the need arises to use said stethoscope, it will quickly and easily slip out through the same slots to be used. This device will protect patients and allow healthcare personnel to know where their stethoscope is at all times. A secondary use is to use this device as a fastening device, for keeping intravenous tubes and lines together and keep them organized. Like the stethoscope, said tubes and lines can be quickly and easily placed into and moved out of said device.

CROSS-REFERENCES TO RELATED APPLICATIONS

This is a non-provisional patent application from a provisional patent application filed on Feb. 6, 2009, Application No. 61/207,008.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates to a disposable device made of foam or flexible plastic that secures a stethoscope around the healthcare worker's neck incorporating a break-away feature that allows the said worker immediate use of the stethoscope. The device also has a secondary feature of being able to secure intravenous tubes or other lines so as to keep the working end of the tubing uncontaminated and within reach of the medical personnel.

2. Description of the Prior Art

This device is like nothing to be found, as far as we have been able to find, to the current date. However, there are a few patents issued for other devices that have to do indirectly with the function of the instant device. The functions of these other devices are completely different and apart from the function of the instant device, but they are listed below.

A prior art device invented by Julian M. Goldman, U.S. Pat. No. 4,451,725, named “Holder for a Stethoscope or the Like,” comprising a holding strap, a patch having a hook, and a pin fastener. This device has the stethoscope rolled up and held onto the healthcare worker's garment, which is completely and totally different than the instant device.

Another prior art device, invented by James E. Ingold, U.S. Pat. No. 6,286,147, named “Stethoscope Support,” comprising a garment with a bell holder pocket normally above the normal pocket, an anchor pad generally on the other side of said garment, and a gripper pad attached to the stethoscope that is releasably attached to the anchor pad. Said device also has at least one sensor to detect the weight load on said device.

The next prior art device, invented by Dwain Kendall, U.S. Pat. No. 5,269,314, named “Stethoscope Cover,” comprised of a fabric cover for the head of a stethoscope. The function of this device is completely different than the instant device, but the patient's safety is better with both of the devices, it does appear.

### BRIEF SUMMARY OF THE INVENTION

When the wearer pulls the stethoscope from around their neck, the device pops loose from the rubber tubing and then remains attached to the metal ear tubes of the stethoscope. This prevents unwanted and obstructive friction sounds from the rubber tubing which is attached to the stethoscope diaphragm or transducer.

In addition to making the wearing of a stethoscope very comfortable and convenient, it also prevents dropping damages, misplacement or loss, and because it's disposable, it reduces the likelihood of contamination from a variety of sources.

Other systems of holding stethoscopes have risks of entanglement on doorknobs, medical equipment, beds, and an endless list of other items they can get caught on. When wearing the stethoscope securely around your neck the device will generally eliminate these hazards and it leaves the medical personnel use of both hands, but when they need their stethoscope it breaks away from around the neck in a split second when every second counts.

### BRIEF DESCRIPTION OF THE DRAWINGS

Further objects, advantages and features of the present invention will appear from the following disclosure and description, including as a part thereof the accompanying drawings, in which:

FIG. 1 is perspective view of the stethoscope keeper or fastening device of the instant device.

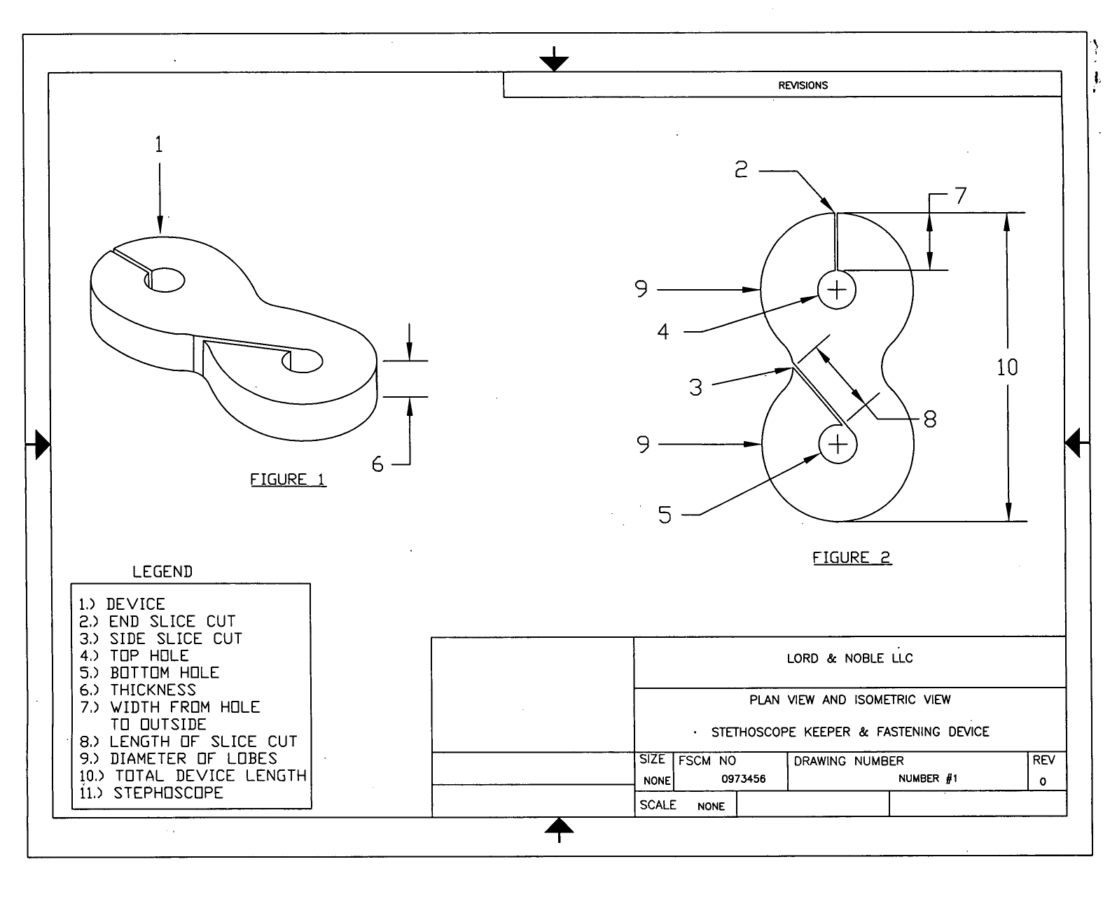

FIG. 2 is the plan view of the current invention, showing the lobes and slots in said lobes.

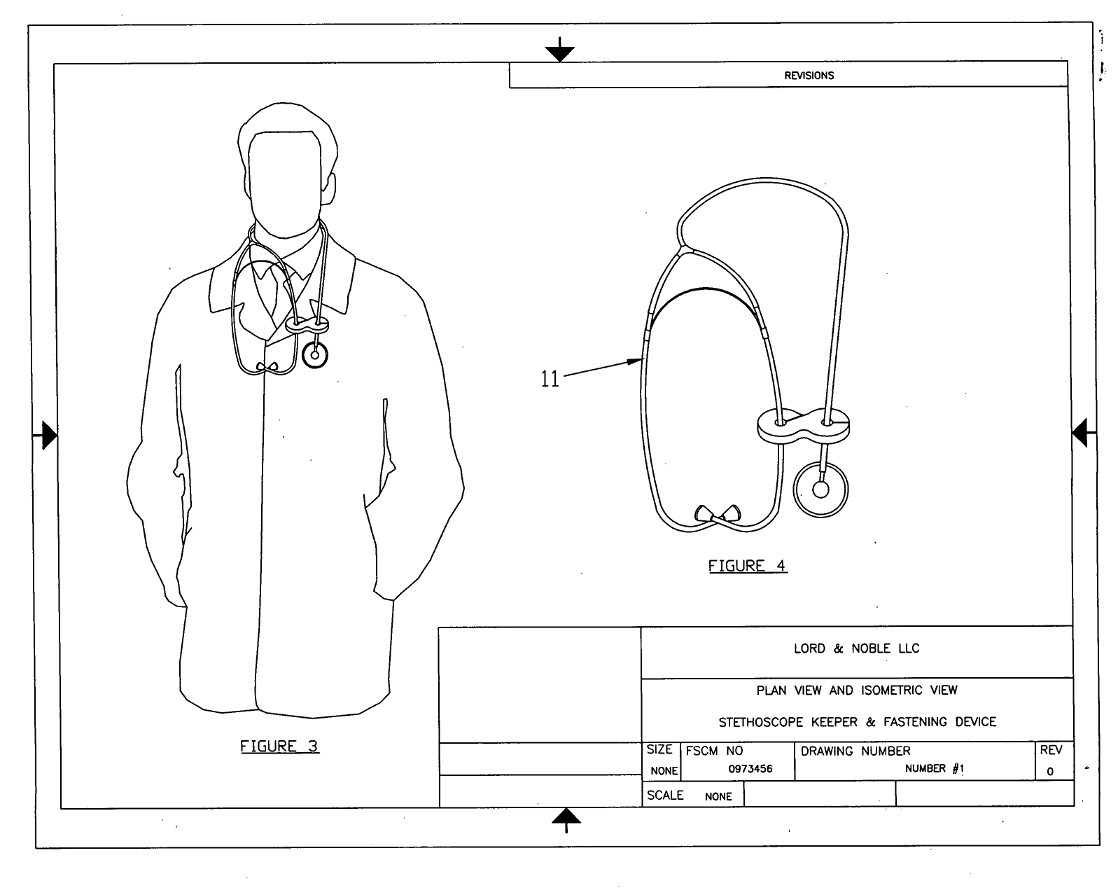

### DETAILED DESCRIPTION OF INVENTION

The instant invention is a stethoscope keeper and fastener device 1 designed to aid in retention of a stethoscope placed around a healthcare worker's neck or in the management of electrical leads for medical devices or intravenous tubing. The device 1 is made of closed cell foam or flexible plastic, figure eight in shape, with two flat sides spanning the entire length of the device 1. The device can be made of varying dimensions to accommodate the particular applications. There is a top hole 4 in the center of the top lobe of the figure eight and a bottom hole 5 in the bottom lobe of the figure eight. There is an end slice cut 2 perpendicular from the outer apex of one distal end, referred to as the top lobe, of the device 1 extending to the top hole 4 at center of the top lobe, and a side slice cut 3 from the exterior center at the narrowest point of the bottom lobe of the device 1 to the bottom hole 5 at the center of that end. The entire device 1 is die-stamped from a flat sheet of closed cell foam or flexible plastic.

This device can me made of a thickness 6 of from 0.30 inches to 0.50 inches. The total length 10 is from one inch to four inches. As the total length 10 increases, the width from hole to outside 7, the length of the slice cut 8, and the diameter of the lobes 9 will all have to be increased accordingly.

The device 1 is used by connecting one of the stethoscope metal binaurals to the bottom lobe into the bottom hole 5 of the device 1 via the side slice cut 3. The flexible tube of the stethoscope is looped around the wearer's neck and the distal end of the stethoscope is connected to the top lobe into the top hole 4 of the device via the end slice cut 2 at the outside end of the top lobe thus said device 1 securing the stethoscope around the wearer's neck.

When the stethoscope needs to be used, the user simply pulls on the two sides of said stethoscope and the flexible end, inserted into the top hole 4 will easily and quickly slip out of the way of the end slice cut 2 in the device 1, allowing the stethoscope to be used without any spurious sounds being transmitted to the stethoscope user, because the device 1 remains attached to metal binaurals only.

When the instant device is used as a fastener device, the tubes or lines to be kept organized, are inserted through the top hole 4, or the bottom hole 5, depending on how the tubes or lines are set up. The tubes or lines can be quickly and simply taken out of the device 1 as the need arises, and reinserted just as quickly and easily.

I claim:

1. A device for assisting healthcare personnel to keep stethoscopes from falling off their neck, and hitting either the floor or the patient, comprising:
a foam or plastic piece with two lobes;
a hole in the center of both of the lobes;
a slot in each of the said lobes, at different locations, to allow the insertion of the tubing of the stethoscope.

2. The device according to claim 1, wherein said device is used to keep tubes or lines, such as the intravenous tubes, together and organized.
